(19) United States
(12) Patent Application Publication
(10) Pub. No.: US 2012/0061204 A1
(43) Pub. Date: Mar. 15, 2012

(54) BUFFER STORE

(75) Inventor: Kurt Philipp, Grenzach-Wyhlen (DE)

(73) Assignee: ROTZINGER AG, KAISERAUGST (CH)

(21) Appl. No.: 13/319,239

(22) PCT Filed: May 6, 2010
(86) PCT No.: PCT/EP10/56200

§ 371 Date: Nov. 7, 2011

(30) Foreign Application Priority Data
May 6, 2009 (CH) 00708/09

(51) Int. Cl. B65G 47/51

(52) U.S. Cl. 198/339.1; 198/617

(57) ABSTRACT

The invention relates to a buffer store (1) for the dynamic buffer storing of products (135) between a production device (P) and a processing device (V), with an input station (2) and an output station (3) of the buffer store (1) and a conveying line arranged between the input station and the output station, wherein the products (135) can be transported between the input station and the output station by means of product carriers (13), wherein the product carriers (13) are connected by means of conveying means (12) arranged along the conveying line, wherein the buffer store (1) comprises a cleaning unit (5) for automatically cleaning product carriers (13) and wherein the cleaning unit (5) is arranged in a section of the conveying line.

The invention relates to a buffer store according to the preamble of independent claim 1 and to a corresponding method.

### SPECIFICATION

In the prior art, buffer stores of this type are also known as bulk goods stores, chain stores or hanging storage devices. Thus in EP 1378467 a chain store is proposed, in which the products or objects, for example, chocolate bars, bakery articles, cans or mechanical engineering components, are conveyed from a production apparatus to at least one packaging apparatus. The buffer store thereby serves as a compensating apparatus for compensating for fluctuations in the feed rate of products from the production and/or in the packing rate of the packaging apparatus. The buffer store furthermore serves as a compensating device in the case of complete stoppages of operation of the production apparatus or of the packaging apparatus. The buffer store described thereby has several gondolas with several shelves suspended on continuous chains, wherein as a rule each shelf is provided to accommodate one row of products. Each chain is thereby deflected by several sprocket wheels mounted in a frame. The described buffer store has a input station for receiving the products and an output station for delivering the products. The chain with the gondolas connected thereto for loading the gondolas or shelves is guided past the input station and for unloading the gondolas or shelves is guided past the output station. This is usually carried out by drive motors that can be operated independently of one another for driving the chains. The independence is achieved by vertically displaceable, that is, not stationary, deflection pulleys, via which each chain is guided, wherein per chain at least one deflection pulley is arranged on a carriage. The described buffer store thus has a transport path for gondola shelves loaded with products, which leads from the input station to the output station and is located at the top in the buffer store, as well as a transport path for gondolas with empty shelves, which leads from the output station to the input station in the lower region of the buffer store.

One of the disadvantages of this buffer store is that the chain section between the input station and output station in the upper region of the buffer store or the upper transport path with filled gondolas in practice usually comprises more gondolas than the lower transport path, in which the empty gondolas are guided. The result is that many products can be stored in the buffer store, whereby valuable production time must be used until the store is completely emptied. The requirement of realizing increasingly higher capacities and in particular of increasing the loading frequency of the buffer store can mean that the filled heavy gondolas in the store begin to rock with the intermittent drive of the chains, in particular in the region of the deflection pulleys. Another disadvantage lies in that during the conveyance of loaded gondolas in the upper transport path of the buffer store, particularly at higher cycle rates, products can fall off the shelves and can thereby soil the empty shelves of the gondolas beneath, which are located on the lower transport path. Furthermore, it is a disadvantage in the shown store that soiled gondolas have to be cleaned by hand in each case, to which end the chain drive must be halted.

The object of the present invention is therefore to propose a device for the intermediate storage of products, which does not have the disadvantages of the prior art. In particular a more efficient, more wear-resistant and cost-effective buffer store is to be realized, which meets the high performance requirements and which is embodied in a low-maintenance manner, offering, among other things, an improved cleaning option.

This object is attained according to the invention by a device according to independent claim 1 and a corresponding method. Advantageous further developments of the store according to the invention are shown by the dependent claims.

In particular these objectives are achieved by the invention in that the buffer store for dynamic intermediate storage of products between a production apparatus and a processing apparatus, with a input station and an output station and a conveyor line arranged between the input station and output station, wherein the products can be conveyed between the input station and the output station along the conveyor line by means of product carriers, also referred to as conveyor gondolas, wherein the conveyor gondolas are connected by means of one or more conveyor means circulating on the conveyor line. The input station has a charging device for charging the conveyor gondolas with products. The output station has a moveable ejector for ejecting products from the conveyor gondolas onto a receiving device for receiving the ejected products.

Preferably, the conveyor line has a line section leading downwards at the input station with a vertical downward movement of the conveyor gondolas, wherein the charging device is arranged at the side of the line section leading downwards, wherein the conveyor line at the output station has a line section leading upwards with a vertical upward movement of the conveyor gondolas, wherein the ejector and the receiving device are arranged at the side lying opposite on the line section leading upwards, and wherein the buffer store comprises means for uncoupling the movements of the conveyor gondolas in the line section leading downwards at the input station from the conveyor gondolas in the line section leading upwards at the output station. According to the invention, in one line section of the conveyor line the buffer store comprises a cleaning device for cleaning the conveyor gondolas.

One of the advantages of the invention is that the gondolas loaded with products at the input station are firstly transported vertically upwards on the conveyor line and thereafter in the conveyor section lying below in the store towards the output station, in order thereafter to be unloaded at the output station in the line section leading upwards, it being achieved hereby that the store can be emptied more quickly at the end of production.

The store, operating according to the “first-in/first-out” principle, furthermore has the advantage that the first loaded gondola is available at the output station more quickly compared to the prior art, so that the unloaded products can be conveyed more quickly to the packaging apparatus. Moreover, in the buffer store according to the invention the empty gondolas are now arranged in the conveyor section at the top in the buffer store. Thus there are no longer any products in this section that could fall onto the gondolas lying beneath and soil them.

Another advantage of the system lies in that there is a much shorter throughput time (chain length) in the filling from the inlet to the outlet, i.e., the product is ready for unloading at the outlet in a shorter time. There are always far fewer products in the store. In the store according to the invention only at least 102 gondola shelves need to be filled with products in the lower transport path, while in a comparable store in the prior art at least 240 gondola shelves are to be filled in the upper transport path. In general, the products reach the packaging station in a shorter time in the store according to the invention when the product flow is guided at the bottom through the store. At the end of production the store is also more quickly emptied thereby. The buffer store is thus embodied as a dynamic store, wherein the filling of the buffer store can be uncoupled from the emptying of the buffer store. This is preferably carried out by means of a programmable logic controller (PLC).

Furthermore, it is advantageous that when systematically only the gondolas in the lower chain strands or in the lower transport path are to be loaded with products, products no longer fall onto the empty gondola shelves. Following disturbances are no longer caused as a result at the input station or at the inlet or at the output station or at the outlet of the store.

Another advantage of the invention lies in that the cleaning device or washing machine is permanently installed in the conveyor line of the buffer store. All of the gondolas can thus be automatically and independently cleaned according to predetermined criteria. The washing machine preferably has a pre-cleaning device, a main device or cleaning device and a drying device. The pre-cleaning and main cleaning each has a spray chamber with nozzles for cleaning the product carriers by means of a fluid. Fluid means a liquid or a gas, for example, water, air, oils and gases. Preferably, the gondolas are sprayed with liquid and detergent. After this pre-cleaning, the gondolas are cleaned in the true sense in a different section of the washing plant, for example, in that they are hosed off. In a subsequent section of the washing plant, the product carriers or gondolas are dried, for example, with hot air. Instead of drying, it can be provided for the shelves of the product carriers to be blown with cold air. Drying and/or blowing take place in continuous operation at slow speed. For this purpose the store is usually to be emptied beforehand. A cleaning during production is fundamentally possible. Since the conveyance of the filled gondolas during the production phase, which is also referred to as production operation or buffer store operation, takes place in the conveyor section at the bottom of the store, there are only empty gondolas in the region of the washing machine, so no product reaches the washing zone of the cleaning device. When the washing machine or cleaning device is arranged following the output station, the transport direction or conveyor direction of the chain in this case does not need to be reversed, since the gondolas are conveyed through the washing machine in the provided direction. The washing machine can be arranged at the inlet or at the input station, as well as at the outlet or at the output station of the store overhead. For this purpose a chain loop out of the store is then laid through the washing machine by means of additional deflection sprocket wheels. The gondolas can thus remain suspended in the chain and do not need to be hooked in or unhooked. This makes it possible to omit two technically complex and expensive handling operations. The whole washing machine is placed on a platform so that the customary accessibility is still ensured below in the inlet and outlet region of the store.

The arrangement according to the invention of the washing machine likewise provides the advantage that the full store capacity of the buffer store is retained, since in the store with the suggested arrangement no carriage stroke is lost either. The store can be constructed in the customary vertical design with regard to a corresponding store capacity. When the washing machine is arranged in the inlet region, the installation length of the store system is not usually much larger due to the washing machine, since a necessary loading belt of the store is still available, which has an effect on the overall length of the store system.

Another advantage is to be seen in that the shelves of the gondolas no longer need to be cleaned manually at the outlet of the store according to the invention. Until now there has been the problem that with the product flow through the upper region of the store, the gondolas at the outlet or at the output station were moved from the top downwards. The result of this was that, during the cleaning of the gondola shelves, the already cleaned gondolas were cycled or conveyed downwards. However, due to the cleaning of the soiled gondolas following from above, the gondolas already cleaned and conveyed downwards could be soiled or contaminated again, for example, by falling particles or dripping soiled detergent. This problem no longer exists with the proposed device, since the cleaning takes place in cleaning phase in the conveyor direction guided from the bottom upwards, and thus only the clean gondolas are conveyed upwards.

In another embodiment variant of the invention, in the downward-leading line section the buffer store comprises a cleaning device for cleaning the conveyor gondolas arranged ahead of the input station. One advantage of the invention lies in that the conveyor gondolas can be cleaned automatically and independently by means of corresponding control means of the buffer store. To this end, after the emptying of the store has been completed for the cleaning process the transport direction of the chain equipped with gondolas must be reversed if the washing machine is localized in the inlet region, that is, at the input station of the store, so that the soiled gondolas can be moved from the bottom upwards through the washing machine. This embodiment according to the invention of the buffer store is advantageous in particular when for instance the necessary space conditions for arranging a washing machine are not available at the output station.

In a further embodiment variant of the invention, the products for intermediate storage are stored by means of the buffer store on product carriers. The product carriers are thereby moveably arranged on two endless conveyor means, for example, chains, arranged essentially parallel to one another. The products are thereby conveyed from an entry station, at which the product carriers are loaded with products, to an exit station, at which the product carriers are unloaded. At the entry station the product carriers are conveyed upwards in this embodiment variant. To unload the product carriers, they are conveyed downwards at the exit station in a manner such that the loaded product carriers, which are also referred to as conveyor gondolas or gondolas, accordingly are conveyed essentially through the upper region of the buffer store from the entry station to the exit station. In this embodiment variant, the lower region of the buffer store has the cleaning device. The endless conveyor means, for example, chains, are looped through the cleaning device such that the product carriers can be automatically cleaned during the buffer store operation or mode as well as in a cleaning operation or mode, when all of the product carriers have been emptied. In the buffer store mode, loaded as well as empty product carriers are present in the buffer store.

In another embodiment variant of the invention, the buffer store comprises an emptying device for emptying product carriers, wherein the emptying device is arranged upstream of the cleaning device.

One of the advantages of the invention is thereby that it can be ensured that all of the shelves of the product carriers, which are also referred to here as gondolas or conveyor gondolas, are free from products, product residue, other undesirable residue, etc. Since product carriers are usually suspended on the conveyor means, for example, chains, in a swiveling manner, an emptying device can be released by a tipping mechanism, for example, in that the free end of a product carrier is deflected by means of deflection means, so that each shelf is in a tilted position and the products slide off.

The invention is explained in more detail below based on exemplary embodiments shown in the drawings. The drawings and their description hereby show further essential features and advantages of the invention.

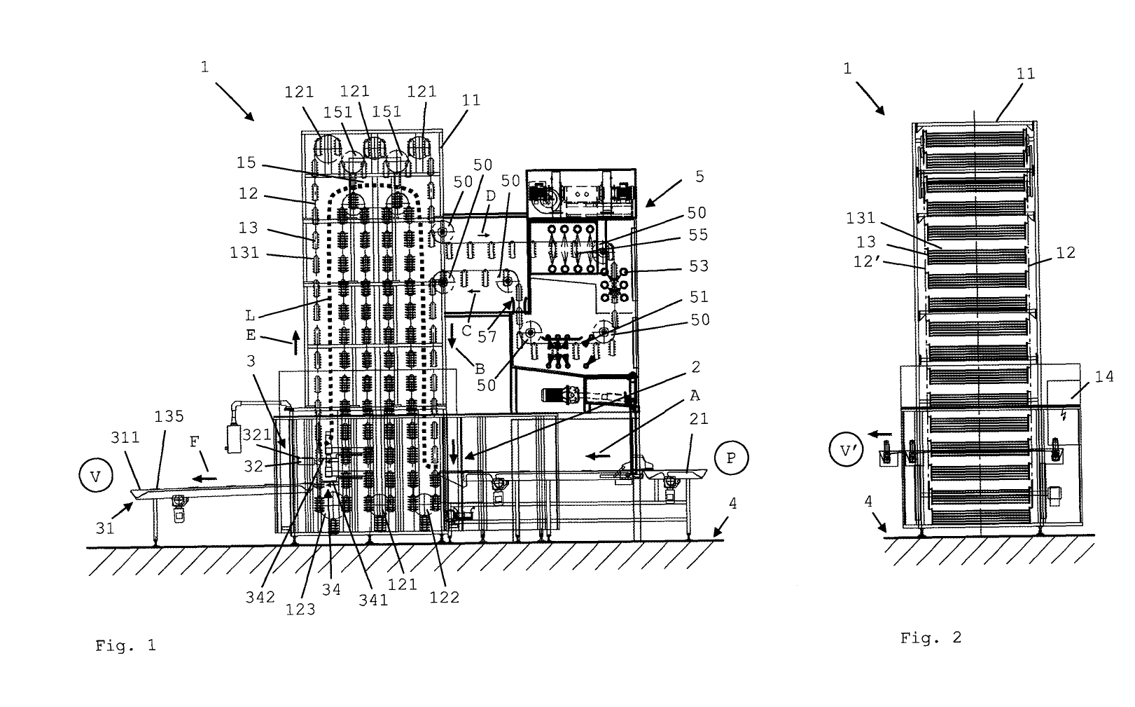

FIG. 1 shows a diagrammatic and simplified representation of the bulk goods store according to the invention, which is interposed between a production apparatus and a processing apparatus, wherein the processing apparatus is usually embodied as a packaging apparatus and wherein a cleaning device is arranged in the transport path of the input station;

FIG. 2 shows a diagrammatic and simplified representation of the buffer store in a side view and

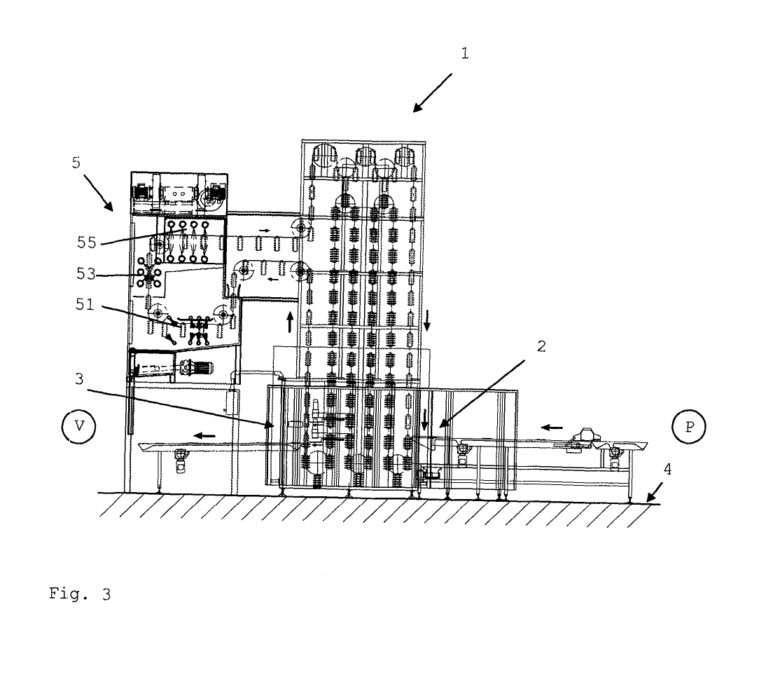

FIG. 3 shows a further embodiment of the device according to the invention, wherein the cleaning device is arranged directly downstream of the output station in the transport path leading upwards.

FIG. 1 illustrates a buffer store 1 for products 135 with a input station 2 and an output station 3, with a conveyor line running between the input station and the output station, wherein the products 135 can be conveyed by means of conveyor gondolas 13 between the input station and the output station, wherein the conveyor gondolas 13 are connected by means of one or more conveyor means 12, 12′ circulating along the conveyor line, wherein the input station 2 comprises a charging device 21 for charging the conveyor gondolas 13 with products 135 and wherein the output station 3 comprises a moveable ejector 341 for ejecting products 135 from the conveyor gondolas 13 and a receiving device 31 for receiving the ejected products 135. The conveyor line has at the input station 2 a line section leading downwards with a vertical downward movement of the conveyor gondolas, wherein the charging device 31 is arranged at the side of the line section leading downwards. The conveyor line has at the output station 3 a line section leading upwards with a vertical upward movement of the conveyor gondolas, wherein the ejector 341 and the receiving device 31 are arranged opposite at the side of the line section leading upwards. The buffer store 1 comprises means 122 for uncoupling the movements of the conveyor gondolas 13 in the line section leading downwards at the input station 2 from the conveyor gondolas 13 in the line section leading upwards at the output station 3. The conveyor means 12, 12′ can be operated in a forward or backward manner, that is, reversibly.

In the line section leading upwards, the buffer store comprises a cleaning device 5 for cleaning the gondolas 13 and arranged downstream of the output station 3.

The upward movement of the conveyor gondolas 13 can be carried out continuously in the line section leading upwards. The upward movement of the conveyor gondolas 13 in the line section leading upwards can also be carried out intermittently. The receiving device 31 can be realized as a conveyor with a circulating conveyor belt 311 for receiving the ejected products 135 and for delivering the products to at least one processing station V. The conveyor is usually arranged rigidly at the output station 3. The output station 3 can comprise a plurality of ejectors 341, 342 for ejecting the products 135 and a plurality of corresponding conveyors 31, 32 for receiving the products. The horizontal forward and backward movement of each ejector 341, 342 is thereby realized to be independent of the horizontal forward and backward movement of every other ejector. The receiving device 31 for receiving the products 135 can be realized as a plate 311, 321, wherein the plate can be embodied in a swiveling or tilting manner for delivering the products to a processing station V. The receiving device 31 can comprise plates and conveyors for receiving the products 135. The conveyor means 12, 12′ are usually realized as endless chains and/or as endless belts. The chains are thereby arranged circulating via sprocket wheels, for example. The chains 12, 12′ are arranged essentially parallel to one another. At least two drives are provided for the chains, wherein each drive drives a shaft, which has corresponding sprocket wheels. One drive conveys the product carriers 13 at the entry station 2 by means of the conveyor means 12. The other drive conveys the product carriers 12 at the exit station 3 by means of the conveyor means 12. The drives can be controlled independently of one another. Each drive can be controlled and/or regulated by means of a control 14. The synchronization of the vertical upward movement of the conveyor gondolas 13 with the unloading movement of the ejector 341 is realized in the line section leading upwards, for example, by means of a control 14. The synchronization of the vertical downward movement of the conveyor gondolas 13 in the line section leading downwards with the loading cycle of the charging device 21 is likewise realized by means of the control 14. The fixed sprocket wheels or deflection pulleys are labeled by reference numbers 121, 122, 123. Reference number 122 designates a fixed deflection pulley, which is driven by a drive. The deflection pulley 122 is thus embodied as a drive wheel. Reference number 123 likewise designates a fixed drive wheel, which is driven by a separate drive. The strand side of the conveyor means 12 can thus be driven in the region of the entry station 2 by means of the drive wheel 122 independently of the strand side of the conveyor means 12 in the region of the exit station 3. The drive wheel 123 is responsible for the movement or drive direction and drive speed of the conveyor means 12 in the region of the exit station. If the conveyor speed of the conveyor means 12 at the entry station 2 deviates from that at the exit station 3, this difference is compensated by the carriage 15. The sprocket wheels or deflection pulleys arranged on the vertically displaceable carriage 15 are labeled by reference number 151. The cycle of the loading of the product carriers 13 with products 135 at the entry station 2 is uncoupled by means of the two drives independent of one another from the cycle of the unloading of the products 135 from the product carriers 13 at the exit station 3.

The dashed line L shows the boundary between essentially two regions in the store, wherein the one region, arranged rather at the top in the store, comprises the gondolas with empty shelves, and wherein the other region comprises the gondolas with the shelves loaded with products. This region is also described as lying at the bottom of the store. In this case four deflection pulleys 151 are arranged on the carriage 15, wherein in each case a loop of the chain 12 with filled gondolas is guided on the lower two deflection pulleys. Gondolas with empty shelves circulate around the upper two deflection pulleys 151. The loops with filled gondolas are also described as a transport path lying at the bottom in the store. This section of the conveyor line is referred to as the store line. The store line is embodied in a variable manner, since its length is variable, whereby the number of the filled gondolas is increased or reduced. The buffer store thus has a variable store capacity. The loops and strand sides of the chain 12, which have empty gondolas, are referred to as the upper transport path. The representation shown shows the store in the so-called production phase. In this phase products are effectively stored intermediately. In the so-called cleaning phase, as shown, the gondolas in the upper as well as in the lower transport path are usually empty.

The arrow A shows the conveyor direction of the products 135 during the production phase. The arrows B, C, D and E show the transport direction or conveyor direction of the gondolas in the store during the production phase. The arrow F shows the production flow of the products 135 removed from the store, wherein the products are guided to the packaging station V.

According to the invention, the washing machine 5 or cleaning station has three cleaning stages, wherein reference number 51 designates a pre-cleaning device or spray chamber. Reference number 53 designates a cleaning device, hosing chamber or cleaning chamber. The washing machine comprises in addition a drying device or hot air chamber labeled by reference number 55. The chains 12, 12′ are thereby looped through the washing machine 5 and deflected about deflection pulleys or sprocket wheels 50. The washing machine can also have fewer or additional cleaning stages. The guidelines and standards of the U.S. Food and Drug Administration (FDA), Good Manufacturing Practice (GMP) rules or the like are decisive in the case of products 135 for the field of foodstuffs. The cleaning of machine parts, in this case in particular the gondolas 13 and their shelves 131, is important, for example, in the case of food, in which it must be ensured that no residue from peanuts or nuts are present on the gondolas. In this manner the production of products 135, for example, special foods for allergy sufferers, is facilitated considerably by the proposed invention, wherein required standards can be met.

FIG. 2 shows a diagrammatic and simplified representation of the buffer store 1 in a side view. At the output station 3 the intermediately stored products 135 are ejected by means of the ejector 341 onto the receiving device 31. The receiving device 31 transports the products subsequently in the direction of the packaging station V for further processing. The control of the buffer store is labeled by reference number 14. The control can be arranged centrally in a cabinet at the buffer store. The drives for the input station 2, the conveyor line and the output station 3 are controlled in particular by means of the control. Drives can be realized as electric motors with and without transmission. Drives can be realized as linear motors. Drives can be realized as pneumatic or hydraulic slider cylinders. Signals from sensor means can also be fed to the control 14 in order to optimize the control of the drive or drive means or to adapt them to changed operating conditions, for example, fluctuations in temperature or wear on machine parts.

FIG. 3 illustrates a further embodiment of the device according to the invention, wherein the cleaning device 5 is arranged directly downstream of the output station 3 in the transport path leading upwards. The cleaning device or washing machine is embodied to clean the conveyor gondolas 13. The conveyor chains 12, 12′ are guided in an additional loop through the washing machine.

The cleaning device 5 can also be embodied as a bath, wherein the product carriers 13 for cleaning are conveyed through a fluid bath at a low speed or with respectively brief temporary stoppage, in order subsequently to be dried outside the bath.

### LIST OF REFERENCE NUMBERS

1 Bulk goods store, store, hanging storage device
11 Frame, frame construction
12 Chain, conveyor chain
12′ Chain, conveyor chain
121 Sprocket wheel, wheel
122 Drive wheel, drive, chain drive wheel
123 Drive wheel, drive, chain drive wheel
13 Conveyor gondola, product carrier, gondola
131 Storage area, shelf, plate, gondola shelf
135 Product, bulk goods
14 Control, control unit, regulation, power supply
15 Carriage
151 Sprocket wheel, wheel
2 Input station, entry station
21 Conveyor
3 Output station, exit station
31 Conveyor
311 Storage area
32 Conveyor
321 Storage area
34 Conveyor, receiving device, plate
341 Ejector, slider
342 Ejector, slider
4 Assembly plane, floor
5 Cleaning station, washing machine
50 Deflection, deflection pulley
51 Pre-cleaning device, spray chamber
53 Cleaning device, hosing chamber, cleaning chamber
55 Drying device, hot air chamber
57 Emptying device, swiveling device
A Arrow
B Arrow
C Arrow
D Arrow
E Arrow
F Arrow
L Line
P Production station
V Processing station, packaging station
V′ Processing station, packaging station

1. A buffer store (1) for the dynamic intermediate storage of products (135) between a production apparatus (P) and a processing apparatus (V), with an input station (2) and an output station (3) of the buffer store (1) and a conveyor line arranged between the input station and the output station, wherein the products (135) can be conveyed between the input station and the output station by means of product carriers (13), wherein the product carriers (13) are connected by means of conveyor means (12, 12′) arranged along the conveyor line, characterized in that the buffer store (1) comprises a cleaning device (5) for automatic cleaning of the product carriers (13), wherein the cleaning device (5) is arranged in a line section of the conveyor line.

2. The buffer store (1) according to claim 1, characterized in that the cleaning device (5) of the buffer store (1) comprises a spray chamber (53) for cleaning the product carriers (13) by means of a fluid.

3. The buffer store (1) according to one of claim 1 or 2, characterized in that the cleaning device (5) of the buffer store (1) comprises a pre-cleaning device (51) for pre-cleaning the product carriers (13) during operation, wherein the pre-cleaning device (51) is arranged upstream of the spray chamber (53).

4. The buffer store (1) according to one of claims 1 through 3, characterized in that the cleaning device (5) of the buffer store (1) comprises a drying device (55) for drying the product carriers (13), wherein the drying device (55) is arranged downstream of the spray chamber (53).

5. The buffer store (1) according to one of claims 1 through 4, characterized in that the buffer store (1) comprises an emptying device (57) for emptying product carriers (135), wherein the emptying device is arranged upstream of the cleaning device (5).

6. The buffer store (1) according to one of claims 1 through 5, characterized in that the conveyor line at the output station (3) has a line section of the conveyor line leading upwards with a vertical upward movement of the product carriers (13), wherein the cleaning device (5) is arranged in the line section of the output station (3) leading upwards.

7. The buffer store (1) according to one of claims 1 through 5, characterized in that the conveyor line at the input station (2) has a line section of the conveyor line leading downwards with a vertical downward movement of the product carriers (13), wherein the cleaning device (5) is arranged in the line section of the input station (2) leading downwards.

8. The buffer store (1) according to one of claims 1 through 7, characterized in that the conveyor means 12, 12′ can be driven reversibly.

9. The buffer store (1) according to one of claims 1 through 8, characterized in that the cleaning device (5) has means for protecting the conveyor means (12, 12′) in order to exclude them from the cleaning.

10. A method for cleaning product carriers (13) of a buffer store (1) embodied for the intermediate storage of products (135), which is arranged between a production apparatus (P) and a processing apparatus (V), wherein the buffer store (1) has a conveyor line, along which the products (135) are conveyed by means of product carriers (13) moveably arranged on conveyor means (12, 12′) from an input station (2) to an output station (3), characterized in that the buffer store (1) has a cleaning device (5) by means of which the product carriers (13) of the buffer store (1) are automatically cleaned, wherein the cleaning of the product carriers (13) can be carried out automatically in a buffer store operation for the intermediate storage of products (135), as well as in a cleaning operation.

11. The method according to claim 10, characterized in that the product carriers (13) are automatically cleaned by means of a spray chamber (53) of the cleaning device (5) during operation.

12. The method according to one of claim 10 or 11, characterized in that the cleaning device (5) has a pre-cleaning device (51) by means of which the product carriers (13) are automatically pre-cleaned during operation.

13. The method according to one of claims 10 through 12, characterized in that the cleaning device (5) has a drying device (55), by means of which the cleaned product carriers (13) are automatically cleaned during operation.

14. The method according to one of claims 10 through 13, characterized in that the products (135) are conveyed by means of the product carriers (13) of the buffer store (1) from an input station (2) of the buffer store to an output station (3) of the buffer store, that the product carriers (13) for loading with products (135) are guided past the input station (2), that the product carriers (13) for unloading the products (135) are guided past the output station (3) and that the empty product carriers (13) are cleaned by means of the cleaning device.

15. The method according to one of claims 10 through 14, characterized in that the product carriers (135) in the cleaning operation are conveyed in a direction along the conveyor line which corresponds to the opposite direction of the conveyance of the product carriers (135) in buffer store operation.
